(19) United States
(12) Patent Application Publication
(10) Pub. No.: US 2025/0153609 A1
(43) Pub. Date: May 15, 2025

(54) METHOD AND SYSTEM FOR CHARGING A LOW VOLTAGE BATTERY WITH A SOLAR PANEL IN AN ELECTRIC VEHICLE

(71) Applicant: FCA US LLC, Auburn Hills, MI (US)

(72) Inventors: Mark J. Miller, Novi, MI (US); Mala Sharma, Rochester Hills, MI (US)

(21) Appl. No.: 18/505,232

(22) Filed: Nov. 9, 2023

(51) Int. Cl. B60L 58/13; B60L 8/00

(52) U.S. Cl. CPC B60L 58/13; B60L 8/003; B60L 2240/54

(57) ABSTRACT

A system and method for operating an electric vehicle having a low voltage battery includes waking-up a controller after a time threshold, determine a state of charge of the low voltage battery and, when the state of charge of the low voltage battery is less than a state of charge threshold, charging the low voltage battery from a solar panel.

### FIELD

The present disclosure relates to battery charging in an electric vehicle, and, more particularly, to a method and system for charging a low voltage battery using a solar panel.

### BACKGROUND

This section provides background information related to the present disclosure which is not necessarily prior art.

In an electric vehicle, the drive components, such as the motors, operate from a high voltage battery. Typical electric vehicles range from 350 volts to 800 volts. Electric vehicles also have numerous components that operate on standard low voltage systems such as 6 volts, 12 volts or 48 volts. Therefore, a 12 volt battery is provided in a typical electric vehicle. A 12 volt battery in an internal combustion engine system has an alternator that is used to charge the battery during operation. This is not the case for a 12 volt battery within an electric vehicle. The 12 volt battery in an electric vehicle is typically charged by the high voltage battery. The high voltage battery is therefore depleted in the amount corresponding to the amount of charge provided to the 12 volt battery.

### SUMMARY

This section provides a general summary of the disclosure and is not a comprehensive disclosure of its full scope or all of its features.

In one aspect of the disclosure, a method for operating an electric vehicle having a low voltage battery includes waking-up a controller after a time threshold, determine a state of charge of the low voltage battery and, when the state of charge of the low voltage battery is less than a state of charge threshold, charging the low voltage battery from a solar panel.

In another aspect of the disclosure, a system for operating an electric vehicle having a low voltage battery includes a controller programmed to wake-up the controller after a time threshold, determine a state of charge of the low voltage battery and, when the state of charge of the low voltage battery is less than a state of charge threshold, control the charging of the low voltage battery from a solar panel.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagrammatic view of an electric vehicle having the low voltage battery charging system 12 according to the present disclosure.

FIG. 2 is a flowchart of a method for operating the low voltage battery charging system of FIG. 1.

Corresponding reference numerals indicate corresponding parts throughout the several views of the drawings.

### DETAILED DESCRIPTION

Example embodiments will now be described more fully with reference to the accompanying drawings.

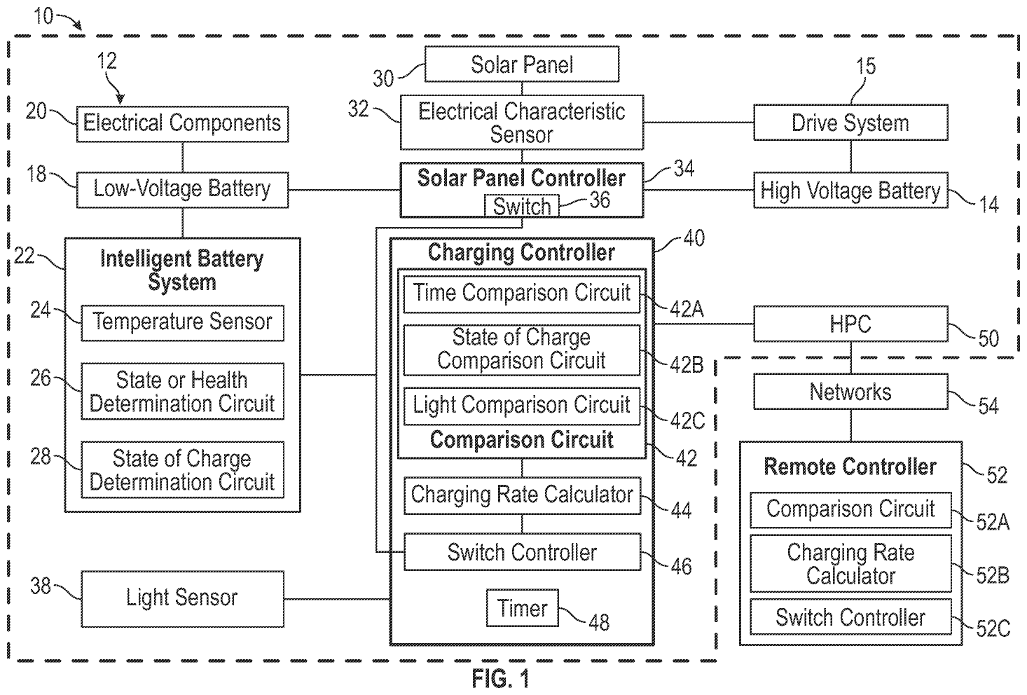

Referring now to FIG. 1, a block diagrammatic view of an electric vehicle 10 having a low voltage charging system 12 is set forth. The electric vehicle 10 has a high voltage battery 14 in a drive system that includes, but is not limited to, motors located at one or more of the vehicle wheels or the drive axles associated therewith. The vehicle 10 also includes a low voltage battery 18. The low voltage battery is used for powering various electrical components 20 such as the entertainment system, the lighting system, the climate control system and the like. Low voltage means the battery voltage used for powering vehicle accessories and not powering the drive motor. Examples of low voltage are 48 volts or less. Examples of high voltage is 350 volts or greater.

The low voltage battery 18 is in communication with an intelligent battery system 22. The intelligent battery system 22 is located at or near the low voltage battery 18 within the vehicle 10. The intelligent battery system 22, in one example, is a controller that is microprocessor-based and has various components and circuits used to determine the electrical characteristics of the low voltage battery 18. In another example, the intelligent battery system 22 is a plurality of separate components joined together in a single housing. For example, the intelligent battery system 22 includes a temperature sensor 24, a state of health determination circuit 26 and a state of charge determination circuit 28. The temperature sensor 24 generates a temperature signal corresponding to the temperature of the battery. The state of health determination circuit 26 determines the state of health of the low voltage battery 18 and generates a state of health signal corresponding thereto. The state of charge determination circuit 42B determines the state of charge of the low voltage battery and generates a state of charge signal corresponding thereto. The charging of some battery chemistries changes as the temperature, state of health and state of charge changes.

The vehicle 10 includes a solar panel 30 mounted or incorporated therein. The solar panel 30, in one example, is located on a roof of a vehicle. However, other locations for the solar panel 30 include the hood, the trunk or decklid or on various windows should a clear solar panel 30 be used. The solar panel 30 generates electricity in the presence of light to provide voltage and a current to the high voltage battery 14 or the low voltage battery 18. An electrical characteristic sensor 32 is associated with the solar panel 30. The electrical characteristic sensor 32 generates a current signal or a voltage signal corresponding to the amount of current or voltage generated at the solar panel in the presence of light. A solar panel controller 34 is used to control the operation of the solar panel 30 and the charging thereof. The solar panel controller 34 acts as a switch or is coupled to an electrically controlled switch 36 used to control whether the high voltage battery 14 or the low battery voltage 18 is charged. Examples of suitable switches 36 include an integrated circuit or a relay.

The switch 36 and the solar panel controller 34 are in communication with a charging controller 40. The charging controller 40 is programmed to control the charging of the low voltage battery 18 and the high voltage battery 14. The charging controller 40 is in communication with a light sensor 38. The light sensor 38 generates a light condition signal that corresponds to the amount of light that falls on the solar panel 30 or on the vehicle 10. The light sensor 38 or the electrical characteristic sensor 32 is used in a vehicle 10 to determine whether sufficient amount of power (voltage, current) is available for charging the batteries 14, 18.

In some examples, a high-performance controller 50 (HPC) is associated with the vehicle. The high-performance controller 50 is programmed to perform various functions in the vehicle including communicating with a remote controller 52.

Referring back to the controller 40, a comparison circuit 42, a charging rate calculator 44 and a switch controller 46 are incorporated therein. The comparison circuit 42 includes a time comparison circuit 42A. That is, the time comparison circuit 42 compares a time from a timer 48 associated with or as part of the controller 40. The time comparison circuit 42A is programmed to wake-up the charging controller 40 to perform various functions based on a timer signal from the timer 48. A time threshold is therefore used so that after a predetermined amount of time (a time threshold) is counted by the timer 48, the time comparison circuit 42A wakes up the rest of the controller 40 so that various functions are performed. That is, the functions of the controller 40 are enabled during waking-up. Selectively operating various functions of the charging controller 40 allow the battery consumption of the vehicle 10 to be reduced especially over long periods without vehicle operation. Therefore, discharging of the batteries of the vehicle 10 is eliminated or reduced.

The comparison circuit 42 also includes a state of charge comparison circuit 42B. The state of charge comparison circuit 42B receives a state of charge signal from the state of charge determination circuit 28 and compares the state of charge of the low voltage battery to a state of charge threshold. When the state of charge of the low voltage battery 18 is below a threshold, the low voltage battery 18 is charged.

A light comparison circuit 42C, in various examples, compares a light condition signal to a light threshold. The light condition signal is generated from the light sensor 38 or derived from the electrical characteristic sensor as a voltage, current or power signal generated from the solar panel 30. The light comparison circuit 42C enables the high voltage battery 14 to charge the low voltage battery 18 when the proper amount of power, current or voltage is not available from the solar panel 30.

A charging rate calculator 44 generates a desired charging rate for the low voltage battery 18. Determining the charging rate calculator in some examples is optional. The charging rate calculator receives one or more of the signals from the intelligent battery system 22. For example, a temperature signal of the low voltage battery, a state of health signal of the battery and a state of charge signal from the battery allows the charging rate calculator to change the charging rate of the low voltage battery 18. The charging rate calculator 44 is continuously operated during the charging process and adjust the charging rate based upon at least one of the signals from the temperature sensor 24, the state of health determination circuit 26 and the state of charge determination circuit 28. In other examples, at least two of the signals from the temperature sensor 24, the state of health determination circuit 26 and the state of charge of determination circuit 28 is used in calculating the charging rate calculator. The charging rate is determined on various conditions sensed by the intelligent battery system 22 and upon the chemical characteristics of the low voltage battery 18. For a particular vehicle design, a predetermined low voltage battery chemistry is used and therefore the charging rate calculator determines the charging rate based thereon.

The switch controller 46 based upon the comparisons in the comparison circuit 42 and the charging rate calculator 44 controls the operation of the switch 36 with a switching signal. The switch controller 46 therefore provides power or the switching signal to switch the switch 36 to allow the low voltage battery 18 to charge from the solar panel or the high voltage battery 14 as described in more detail below.

The high-performance controller 50 provides communication to the remote controller 52 through various types of networks 54 including, but not limited to, a cellular telephone system, a satellite system, a Wi-Fi and the like. The remote controller 52 performs the functions of the charging controller in a remote manner. For example, the functions of the comparison circuit 42 are incorporated in the comparison circuit 52A. The functions of the charging rate calculator 44 are incorporated into the charging rate calculator 52B and the function of the switch controller 46 is incorporated in the switch controller 52C. In another example, a switching signal generated based on the state of charge of the low voltage battery 18 is communicated through the network 54 to the controller 40 or the switch 36.

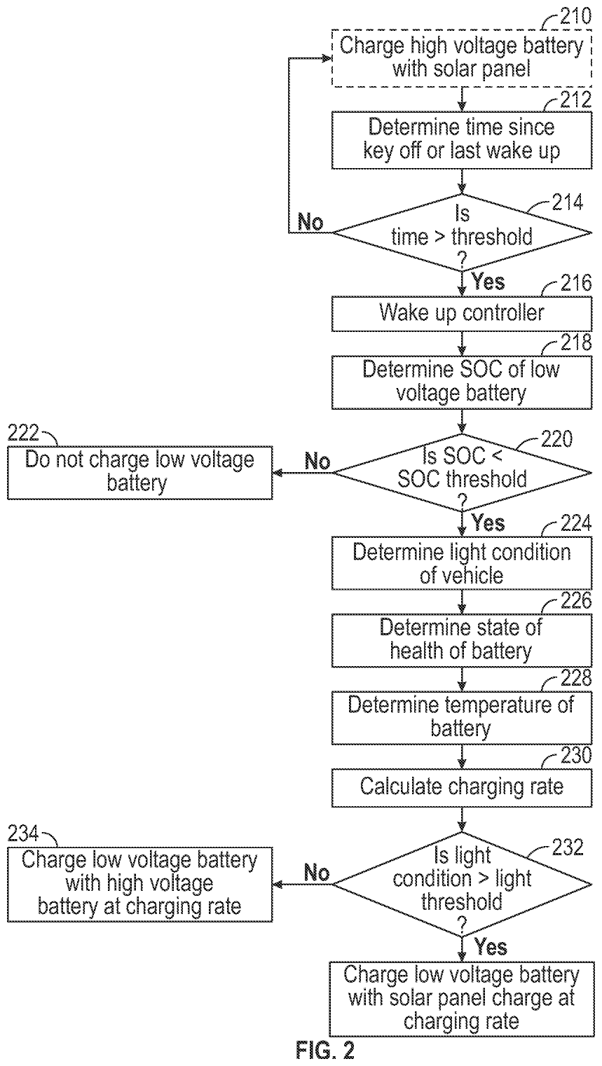

Referring now to FIG. 2, a method of performing charging of the batteries within the electric vehicle is performed. In step 210, an optional step of charging the high voltage battery with the solar panel 30 of FIG. 1 is set forth. As mentioned above, the high voltage battery 14 is charged with the solar panel 30 or, in some examples, is not charged at all using the solar panel 30.

In step 212, a time period from the last key off or since a last wakeup is determined at the charging controller 40. In one example, the method is used during normal operation (driving) of the vehicle 10. As mentioned above, the charging controller has all of the functions except for the timer function enable. When the time or time period from the timer is not greater than the time threshold, step 210 is performed. In step 214, when the time is greater than a time threshold, the charging controller and the other functions wakes up in step 216. Waking up the charging controller 40 allows the various circuits to be powered and function such as the comparison circuit 42, the charging rate calculator 44 and the switch controller 46.

In step 218, the state of charge of the low voltage battery 18 is determined at the intelligent battery system 22. The state of charge signal is communicated to the controller 40 and specifically to the state of charge comparison circuit 42B. In step 220, when the state of charge is not below a state of charge threshold, step 222 does not allow the system to charge the low voltage battery. In step 220, when the state of charge is below a state of charge threshold, step 224 determines a light condition of the vehicle. That is, the light condition corresponds to whether the vehicle is in a sufficient amount light to allow the solar panel to charge the low voltage battery. In step 226, the state of health of the battery is determined. As mentioned above, the state of health determination circuit 26 of the intelligent battery system 22 communicates a state of health signal to the charging rate calculator 44. The term circuit means an electrical circuit formed by but not limited to a microprocessor, an application specific circuit, discrete circuitry in analog or digital form and any control software programmed to control various functions.

In step 228, the temperature of the low voltage battery 18 is determined. The temperature of the low voltage battery 18 is determined at the temperature sensor 24 which is communicated to the charging rate calculator 44.

In step 230, the charging rate is determined at the charging rate calculator 44. The state of charge, the state of health of the battery and the temperature of the battery is used to determine the charging rate. In some calculations, at least two of the above of the state of charge, the state of health of the battery and the temperature of the battery are used in some examples.

In step 232, an optional step of comparing the light condition to a light threshold is performed. When the light condition is not greater than a light threshold, the solar panel 30 is not capable of charging the low voltage battery. Therefore, step 234 performs the charging of the low voltage battery with the high voltage battery by switching the switch 36 to allow the high voltage battery 14 to couple to the low voltage battery 18 and charge therefrom.

In step 232, when the light condition is greater than the light threshold, the low voltage battery is charged with the solar panel at the charging rate determined in step 230 when the charging rate is determined and utilized. The system continually monitors the state of charge or other characteristics of the low voltage battery 18 adjusted according to the conditions at the low voltage battery 18.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for operating an electric vehicle having a low voltage battery comprising:
waking-up a controller after a time threshold;
determining a state of charge of the low voltage battery; and
when the state of charge of the low voltage battery is less than a state of charge threshold, charging the low voltage battery from a solar panel.

2. The method of claim 1 wherein prior to charging the low voltage battery, charging a high voltage battery with the solar panel.

3. The method of claim 2 wherein determining the state of charge of the low voltage battery comprises determining the state of charge of the low voltage battery being equal to or less than 48 volts, said a high voltage battery being equal to or greater than 300 volts.

4. The method of claim 1 further comprising determining a light condition for the vehicle, when the light condition is below a light threshold, charging the low voltage battery with a high voltage battery.

5. The method of claim 1 further comprising determining a charging rate for the low voltage battery and wherein charging the low voltage battery comprises charging the low voltage battery at the charging rate.

6. The method of claim 5 wherein determining the charging rate comprises determining the charging rate based on a state of health of the low voltage battery.

7. The method of claim 5 wherein determining the charging rate comprises determining the charging rate based on a temperature of the low voltage battery.

8. The method of claim 5 wherein determining the charging rate comprises determining the charging rate based on a state of charge of the low voltage battery.

9. The method of claim 5 wherein determining the charging rate comprises determining the charging rate based on at least two of the state of charge of the battery, a temperature of the battery and a state of health of the battery of the low voltage battery.

10. The method of claim 1 further comprising determining a switching signal based on the state of charge at a remote controller.

11. A system for operating an electric vehicle having a low voltage battery comprising:
a controller programmed to
wake-up the controller after a time threshold;
determine a state of charge of the low voltage battery; and
when the state of charge of the low voltage battery is less than a state of charge threshold, control the charging of the low voltage battery from a solar panel.

12. The system of claim 11 wherein the controller is programmed to charge a high voltage battery with the solar panel prior to charging the low voltage battery.

13. The system of claim 12 wherein the controller is programmed to determining the state of charge of the low voltage battery comprises determining the state of charge of the low voltage battery being equal to or less than 48 volts, said a high voltage battery being equal to or greater than 300 volts.

14. The system of claim 11 further comprising a light condition sensor generating a light condition signal corresponding to a light condition at the vehicle, said controller programmed to charge the low voltage battery with a high voltage battery to when the light condition is below a light threshold.

15. The system of claim 11 wherein the controller is programmed to determine a charging rate for the low voltage battery and control charging of the low voltage battery at the charging rate.

16. The system of claim 15 wherein the controller is programmed to determine the charging rate based on a state of health of the low voltage battery.

17. The system of claim 15 wherein the controller is programmed to determine the charging rate based on a temperature of the low voltage battery.

18. The system of claim 15 wherein the controller is programmed to determine the charging rate comprises based on a state of charge of the low voltage battery.

19. The system of claim 15 wherein determining the charging rate comprises determining the charging rate based on at least two of the state of charge of the battery, a temperature of the battery and a state of health of the battery of the low voltage battery.

20. The system of claim 11 wherein a remote controller determines a switching signal based on the state of charge and communicates the switching signal to the switch through a network.
